(19) United States
(12) Patent Application Publication
(10) Pub. No.: US 2018/0272547 A1
(43) Pub. Date: Sep. 27, 2018

(54) ERGONOMIC SCISSORS

(71) Applicant: Lothar Pierre Poppek, Dewey, AZ (US)

(72) Inventor: Lothar Pierre Poppek, Dewey, AZ (US)

(21) Appl. No.: 15/684,404

(22) Filed: Aug. 23, 2017

Related U.S. Application Data
(60) Provisional application No. 62/477,322, filed on Mar. 27, 2017.

(51) Int. Cl. B26B 13/20; B26B 13/28

(52) U.S. Cl. CPC B26B 13/20; B26B 13/28

(57) ABSTRACT

There is disclosed an ergonomic scissors tool and associated methods for performing precise cutting operations in a variety of applications including hair cutting, pet grooming, medical applications, and/or clothing manufacturing, repair, and/or tailoring. One embodiment provides a scissors tool including an upper cutting member extending proximally to distally from an upper digit-receiving eyelet to an upper blade portion, as well as a lower cutting member extending proximally to distally from an upper digit-receiving eyelet to an upper blade portion, where the lower cutting member is disposed beneath and pivotally coupled with the upper cutting member. The upper and the lower blade portions meet at a horizontal cutting plane, and an offset configured for one or both of a user's physiology and the relevant use application separates the upper and the lower digit-receiving eyelets from the horizontal cutting plane. Other embodiments are disclosed.

### REFERENCE TO PENDING PRIOR PATENT APPLICATION

This application claims the benefit under 35 U.S.C. 119 (e) of U.S. Provisional Patent Application No. 62/477,322, filed Mar. 27, 2017 by Lothar Pierre Poppek for “ERGONOMIC SCISSORS,” which patent application is hereby incorporated herein by reference.

### BACKGROUND

Precision scissors and shears are typically used for cutting hair, cloth, paper, or other thin or fine materials. They are oftentimes employed in beauty salons and/or barber shops, pet grooming parlors, surgical environments, clothing manufacturing, repair, and/or tailoring settings, and in the leather and upholstery design, manufacture, and repair industries (e.g., saddles, couches, vehicle interiors, etc.). Many of these cutting applications involve detailed work and require the user of the scissors to exert considerable care and control in performing repetitive finger and hand motions over long periods of time. As a result, the ergonomic design and fit of precision scissors are paramount to the user.

Conventional scissors and shears feature stacked scissor members, each having a blade portion disposed at one end and a handle or grip portion disposed at the other opposing end. The scissor members are generally rotatively fastened in the middle so as to allow the blade portions of the members to be opened and closed by a scissoring motion of a thumb and a finger inserted through eyelets formed within the handle or grip portions. Typically, the handle portion lies within a horizontal plane that is defined by the opening and closing motion of the blade portions. Moreover, existing scissors are manufactured in stock sizes and configurations that are not an ideal fit for many users.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

One embodiment provides a scissors tool for precise cutting operations. The scissors tool includes an upper cutting member extending from an upper handle portion at a proximal end to an upper blade portion at a distal end, the upper handle portion comprising an upper digit-receiving eyelet. The scissors tool further includes a lower cutting member extending from a lower handle portion at the proximal end to a lower blade portion at the distal end, the lower handle portion comprising a lower digit-receiving eyelet, the lower cutting member disposed beneath and pivotally coupled to the upper cutting member such that the upper and the lower cutting members pivot between an open position and a closed position, where: (1) when in the closed position, the upper and the lower blade portions meet along a horizontal cutting plane; (2) an upper offset separates the horizontal cutting plane and the upper digit-receiving eyelet; and (3) a lower offset separates the horizontal cutting plane and the lower digit-receiving eyelet.

Another embodiment provides precision scissors for performing cutting operations. The precision scissors have an upper cutting member pivotally coupled with a lower cutting member, the upper cutting member extending proximally to distally from an upper digit-receiving eyelet to an upper blade portion, the lower cutting member extending proximally to distally from a lower digit-receiving eyelet to a lower blade portion, wherein: (1) the upper and the lower blade portions meet at a horizontal cutting plane; (2) the upper digit-receiving eyelet and the lower digit-receiving eyelet are positioned above the horizontal cutting plane at respective upper and lower vertical offsets from the horizontal cutting plane; and (3) the upper and the lower vertical offsets are sized to accommodate a physiology of a user to achieve an ergonomic alignment during use.

Yet another embodiment provides a precision cutting system. The precision cutting system includes a scissors tool and a fit kit. The scissors tool extends proximally to distally from a handle portion to a blade portion, where the blade portion defines a horizontal cutting plane, and the handle portion comprises two digit-receiving eyelets disposed at a vertical offset from the horizontal cutting plane. The fit kit comprises a number of interchangeable fit shims for customizing the digit-receiving eyelets. Each of the fit shims forms a ring having an identical outer diameter and a varying inner diameter, where the identical outer diameter is configured for insertion into an aperture of at least one of the digit-receiving eyelets, and the varying inner diameter is configured to receive the user's digit and approximates a diameter of the user's digit.

Other embodiments are also disclosed.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1A illustrates a top view of one embodiment of an ergonomically correct and adjustable scissors tool in an open position;

FIG. 1B illustrates a top view of the scissors tool of FIG. 1A in a closed position;

FIG. 1C illustrates a side view of the scissors tool of FIG. 1A in an open position;

FIGS. 2A-2B illustrate respective top and side views of an upper cutting member of the scissors tool of FIGS. 1A-1C;

FIGS. 3A-3B illustrate respective top and side views of a lower cutting member of the scissors tool of FIGS. 1A-1C; and

FIG. 4 illustrates a rear view of the scissors tool of FIGS. 1A-1C;

FIG. 5A illustrates a side view of the upper cutting member of FIGS. 2A-2B, featuring blade-angle and handle-angle adjustment mechanisms;

FIG. 5B illustrates a side view of the lower cutting member of FIGS. 3A-3B, featuring blade-angle and handle-angle adjustment mechanisms;

FIG. 5C illustrates an end view of the scissors tool of FIG. 4, featuring one or more eyelet angle adjustment mechanisms; and

FIG. 6 illustrates a top view of the scissors tool of FIGS. 1A-1C, along with a shim fit kit.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Various embodiments of the systems and methods described herein relate to precision cutting in a variety of settings and industries including, but not limited to, the hair/beauty industry, the pet-grooming industry, in surgical/medical environments, in the clothing manufacture, repair, and/or tailoring industry, the manicure/pedicure industry, the sheet metal fabrication industry, and in the leather and upholstery design, manufacture, and/or repair industries (e.g., saddles, couches, vehicle interiors, etc.). Conventional precision scissors present a number of drawbacks in that, despite costing upwards of several hundred dollars a pair, they are limited to stock sizes and configurations that may or may not fit a particular scissors user.

Moreover, conventional stock scissors typically feature handles that are positioned in-line with, or within a same horizontal plane as, the scissor blades. This arrangement does not provide an ergonomically correct alignment for most users, who use the scissors for detailed, repetitive movement, often for several hours a day. Due to the blade-handle alignment and the oftentimes unsuitable sizing and configuration of conventional scissors, users must torque or twist their gripping hand in order to operate the scissors to the best advantage. This type of misaligned repetitive motion can lead to reduced scissor and user performance, as well as repetitive motion injuries in the wrist, forearm, and shoulder (e.g., tendinitis, bursitis, carpal tunnel syndrome), which can ultimately and negatively impact individual projects, the long-term health of the scissor users, and the associated industries as a whole.

Embodiments of an ergonomic scissors tool disclosed herein are geometrically designed to provide ergonomically optimized alignment during use, as well as adjustability and customization options that allow the user to tailor the scissors to his or her own personal physiology. Tailoring and customization may be achieved via a variety of self-adjustable angles and parameters incorporated into each pair of scissors, as detailed below, or by 3-D printing a custom pair of scissors for each user based on the user's measurements, specifications, and use parameters.

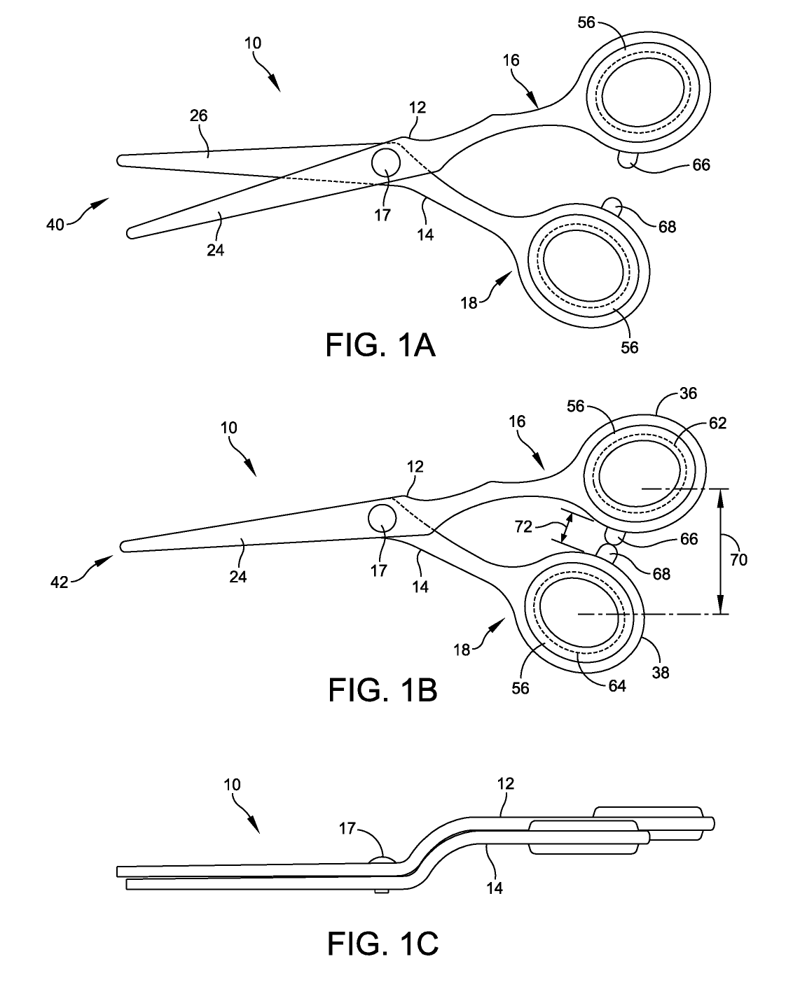

FIGS. 1A-1B illustrate top views of one embodiment of a pair of ergonomically correct scissors 10 in open and closed configurations, respectively. In this embodiment, the scissors 10 may include an upper cutting member 12 and a lower cutting member 14, where the upper cutting member 10 is pivotally coupled with the lower cutting member 14 via any appropriate fastener such as, for example, a tension screw 17.

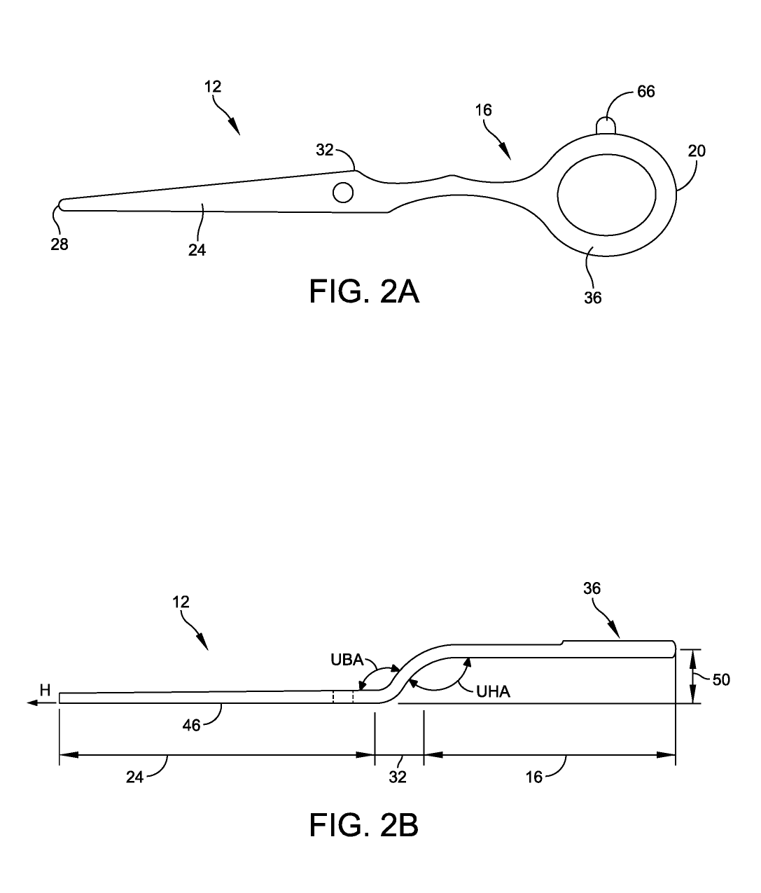

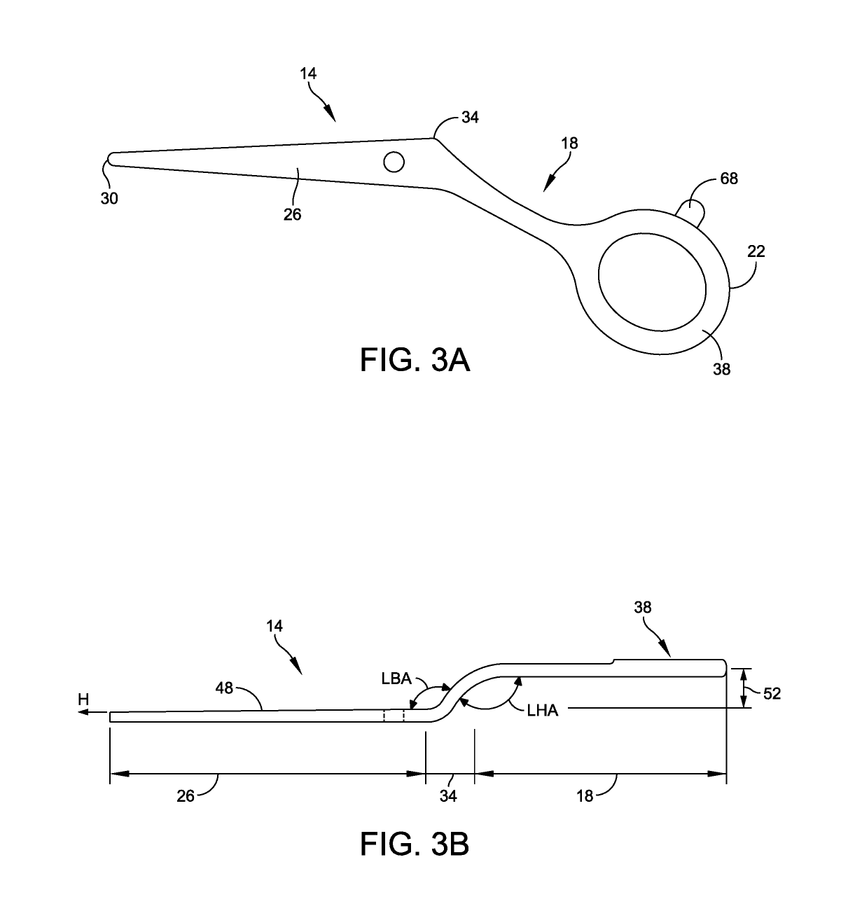

FIGS. 2A-2B detail respective top and side views of the upper cutting member 12, while FIGS. 3A-3B detail respective top and side views of the lower cutting member 14. The upper cutting member 12 and the lower cutting member 14 each include three respective portions: upper and lower handle portions 16, 18 located at proximal ends 20, 22 of the members 12, 14; upper and lower blade portions 24, 26 located at distal ends 28, 30 of the cutting members 12, 14; and upper and lower bend portions 32, 34 located between the handle portions 16, 18 and the blade portions 24, 26, respectively. Thus, the upper cutting member 12 of FIGS. 2A-B includes the upper blade portion 24, the upper bend portion 32, and the upper handle portion 16. Similarly, the lower cutting member 14 of FIGS. 3A-B includes the lower blade portion 26, the lower bend portion 34, and the lower handle portion 18.

The upper and the lower handle portions 16, 18 may respectively terminate proximally in upper and lower digit-receiving eyelets 36, 38, each configured as appropriate to receive a user's finger or thumb for the purpose of manipulating the upper and the lower cutting members 12, 14 between an open position 40 in which the upper and the lower blade portions 24, 26 are scissored apart, shown in FIG. 1A, and a closed position 42 in which the upper and the lower blade portions 24, 26 overlap, as shown in FIG. 1B.

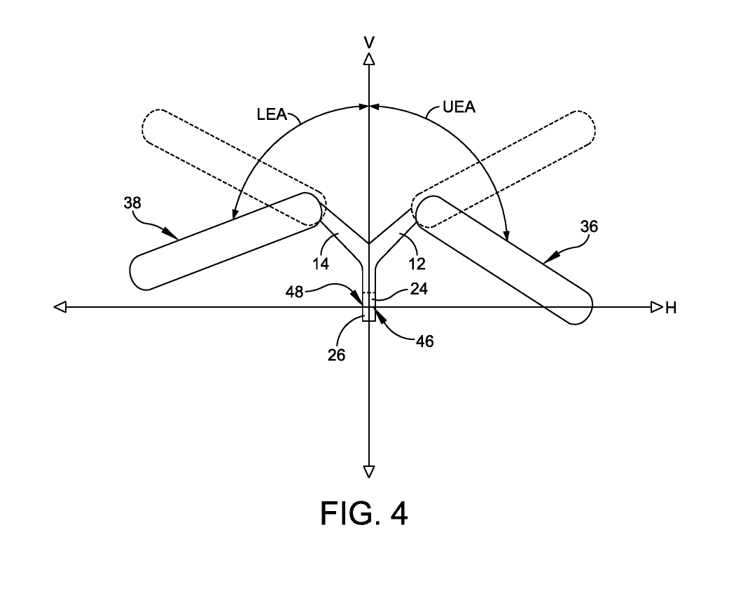

When in the closed position 42, a bottom surface 46 of the upper blade portion 24 and a top surface 48 of the lower blade portion 26 may meet along a horizontal cutting plane, H, and the upper and the lower digit-receiving eyelets 36, 38 may approach a bisecting vertical plane, V, as shown in FIG. 4. Notably, and as shown in FIG. 1B, when in the closed position 42, the upper and the lower digit-receiving eyelets 36, 38 are spaced an eyelet distance 72 from one another. The eyelet distance 72, in turn, defines a digit-spread distance 70 between a center of each of the eyelets 36, 38 when the scissors 10 are in the closed position 42.

The eyelet distance 72 and the digit-spread distance 70 allow for a spread between the gripping fingers during use of the scissors 10, whether in the open or the closed positions 40, 42, and ensure that the user's gripping digits travel a shorter distance when moving between the open and the closed positions 40, 42. Closing the gripping digits only as far as the eyelet distance 72 relieves strain on the gripping fingers (e.g., on the thumb and an opposing finger or fingers) when the scissors are moved into the closed position 42. Traditional scissors typically employ eyelets that meet or touch when in the closed position, which requires the gripping fingers to nearly close or meet and places strain on the gripping fingers. After repetitive use, this strain can lead to a condition called tenosynovitis, or an inflammation in the fluid-filled sheath that surrounds finger/digit tendons, causing joint pain, swelling, and stiffness.

In addition, when the gripping fingers close completely or nearly completely, the user can only access approximately twenty-five percent of his or her hand strength. In contrast, by maintaining an eyelet distance 72 of approximately ¼ inch to ¾ inch in the closed position 42, the user can access approximately 75 percent of his or her hand strength when maneuvering the scissors between the open and the closed positions 40, 42. Further, maintaining the eyelet distance 72 of approximately ¼ inch to ¾ inch eliminates fifty to sixty percent of the medical complications commonly arising from repetitive scissor usage.

The eyelet distance 72 may be maintained by one or more spreaders 66, 68 protruding from the inner edges of the eyelets 36, 38. As discussed above, the spreaders 66, 68 may be sized to provide an eyelet spread 72 between a ¼ inch and ¾ inch. The spreaders 66, 68 may be made of any appropriate material including metal with a rubber or plastic coating or sheath, or they may be formed from hard rubber inserts to prevent an audible click when the spreaders 66, 68 meet in the closed position 42.

The upper and the lower digit-receiving eyelets 36, 38 may be of equal size or they may have disparate sizes as appropriate and/or desired to receive an opposing single or multiple digits.

To further provide an ergonomically correct alignment during use, the upper and the lower bend portions 32, 34 of the cutting members 12, 14 are configured to position the upper and the lower handle portions 16, 18 at respective upper and lower offsets 50, 52 from the horizontal cutting plane, H, as shown in FIGS. 2B and 3B, respectively. In further detail, the upper and the lower bend portions 32, 34 are angled such that the bend portions 32, 34 extend diagonally between the upper and the lower blade portions 24, 26 and the upper and the lower handle portions 16, 18, respectively, to achieve the upper and the lower offsets 50, 52. In one embodiment, each of the upper and the lower offsets 50, 52 may be between 1-2 cm (approximately 0.4 to 0.8 inches).

Specifically, and as shown in FIG. 2B, the upper bend portion 32 is positioned at an upper blade angle, UBA, relative to the upper blade portion 24 and an upper handle angle, UHA, relative to the upper handle portion 16. Similarly, and as shown in FIG. 3B, the lower bend portion 34 is positioned at a lower blade angle, LBA, relative to the lower blade portion 26 and a lower handle angle, LHA, relative to the lower handle portion 18. The upper blade angle, UBA, the upper handle angle, UHA, the lower blade angle, LBA, and the lower handle angle, LHA, may vary as appropriate to optimize ergonomic alignment (e.g., ensure an ergonomic grip on the scissors 10 during use) and user comfort.

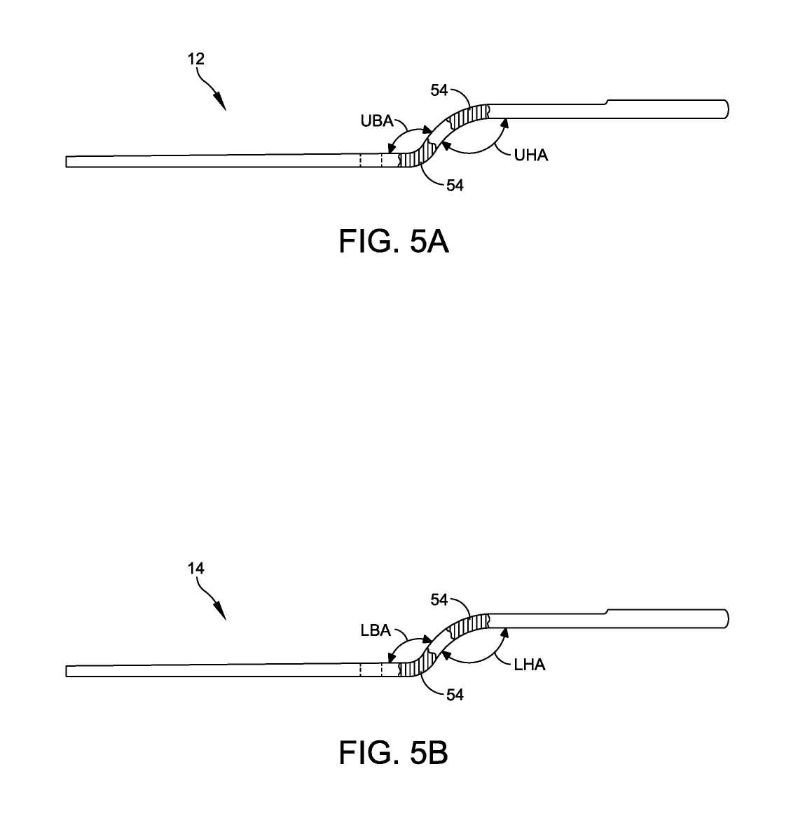

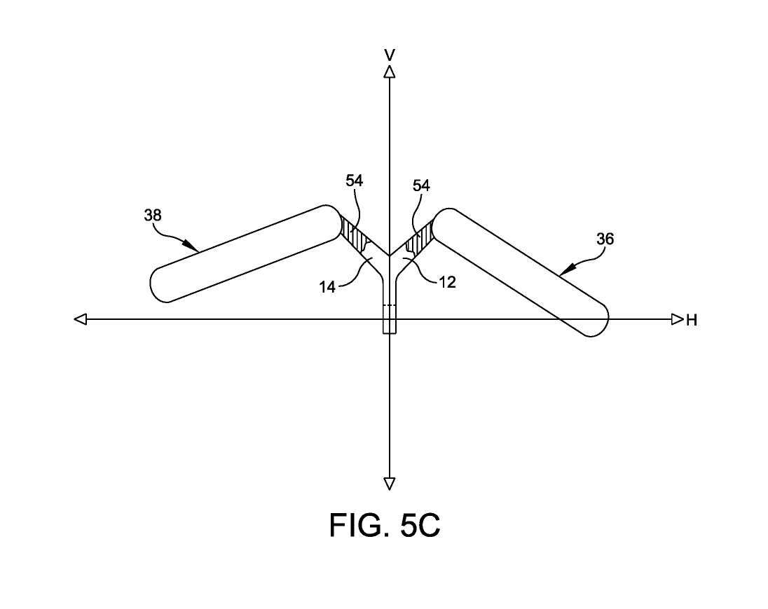

In one embodiment, and as shown in FIGS. 5A-B, the upper and the lower blade angles, UBA and LBA, and the upper and the lower handle angles, UHA and LHA, may be manually adjustable, which, in turn, customizes the height or size of the upper offset 50 between the horizontal cutting plane, H, and the upper eyelet 36 and/or the lower offset 52 between the horizontal cutting plane, H, and the lower eyelet 38, as well as the configuration or positioning of the upper and the lower handle portions 16, 18 relative to the upper and the lower blade portions 24, 26, respectively.

Similar to the adjustability of the angles between the upper and the lower bend portions 32, 34, the upper and the lower blade portions 24, 26, and the upper and the lower handle portions 16, 18 of the cutting members 12, 14, the upper and the lower digit-receiving eyelets 36, 38 may be oriented at adjustable upper and lower eyelet angles, UEA and LEA, relative to the vertical plane, V, as shown in FIG. 4. This additional customization option allows the user to position the eyelets 36, 38 as most appropriate for the user's physiology and/or the particular use application (e.g., cutting hair vs. tailoring clothing vs. performing surgery). In one embodiment, the upper eyelet angle, UEA, may differ from the lower eyelet angle, LEA, as appropriate.

The adjustability of the various angled joints discussed above enables the user to tailor the fit of the scissors to his or her hand, finger, and/or bodily physiology. For example, a tall user who cuts hair for a living may desire a specific set of blade and handle angles to provide a more comfortable, ergonomically correct position relative to customers' heads during the hair-cutting process. A petite user may require a different set of blade and handle angles to achieve the same comfort and performance.

The adjustability of the upper and lower blade angles, UBA and LBA, the upper and lower handle angles, UHA and LHA, and the upper and lower eyelet angles, UEA and LEA, may be achieved through a variety of adjustment mechanisms 54 positioned at the angled joints, as shown in FIGS. 5A-5C. Specifically, embodiments of the adjustment mechanism 54 may comprise a portion or insert of shape-memory material that is plastically deformable through the application of heat, an electrical impulse or current, force (causing a stress in the material), or a combination of one or more of the three. In other embodiments, one or more of the adjustment mechanisms 54 may comprise hardware configured to be positionable between a number of settings or positions from which the user may select. For example, one or more of the adjustment mechanisms 54 may comprise a selectively locking hinge mechanism, a linear ratchet-and-pawl mechanism having a manual release, or a rotary ratchet-and-pawl mechanism having a manual release.

In this embodiment, each of the adjustment mechanisms 54 located (1) between the upper and the lower blade portions 24, 26 and the upper and the lower bend portions 32, 34; (2) between the upper and the lower handle portions 16, 18 and the upper and the lower bend portions 32, 34; and (3) adjacent to the upper and the lower eyelets 36, 38 may be manually manipulated to adjust the upper and lower blade angles, UBA and LBA, the upper and lower handle angles, UHA and LHA, and the upper and the lower eyelet angles, UEA and LEA, as necessary and/or desired by the user. As a result, each pair of scissors 10 may be completely customizable in real time.

Alternatively, each pair of scissors 10 may be custom manufactured via a 3D printing process, thus allowing the user to specify the manufacturing specifications, including angle values or ranges for the upper and the lower blade angles, UBA and LBA, the upper and the lower handle angles, UHA and LHA, and the upper and the lower eyelet angles, UEA and LEA, to fit his or her needs prior to the custom manufacture of the scissors.

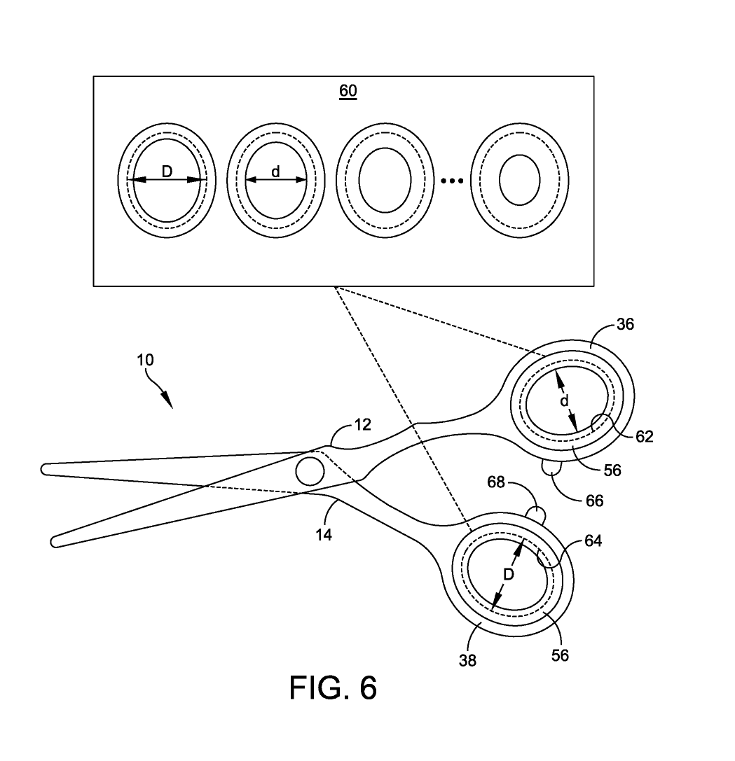

Beyond the adjustability of the key angles discussed above, the scissors 10 may be provided as part of a fit kit 60 that includes a number of eyelet shims 56, as shown in FIG. 6. Each of the shims 56 may be a flexible, generally-round or oval grommet having an outer diameter, D, configured to conform to and be received within respective upper and lower apertures 62, 64 of the upper and the lower digit-receiving eyelets 36, 38. Each of the eyelet shims 56 may have a different inner diameter, d, configured to accommodate a different digit diameter. Thus, selectively inserting a shim 56 within the upper or the lower apertures 62, 64 of the upper or the lower eyelets 36, 38 adjusts the size of the relevant eyelet to accommodate different finger sizes.

The scissors may be formed of any appropriate material or combination of materials. In one embodiment, the blades may be formed of Cutco stainless steel and may feature jagged blade edges. Other components may be formed of plastics and/or polymer coatings as appropriate. As discussed above, the angled joints may be made of shape-memory material that enables customization of the angled joints of the scissors 10.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

1. A scissors tool for precise cutting operations, comprising:
an upper cutting member extending from an upper handle portion at a proximal end to an upper blade portion at a distal end, the upper handle portion comprising an upper digit-receiving eyelet;
a lower cutting member extending from a lower handle portion at the proximal end to a lower blade portion at the distal end, the lower handle portion comprising a lower digit-receiving eyelet, the lower cutting member disposed beneath and pivotally coupled to the upper cutting member such that the upper and the lower cutting members pivot between an open position and a closed position, wherein:
when in the closed position, the upper and the lower blade portions meet along a horizontal cutting plane;
an upper offset separates the horizontal cutting plane and the upper digit-receiving eyelet; and
a lower offset separates the horizontal cutting plane and the lower digit-receiving eyelet.

2. The scissors tool of claim 1, wherein:
the upper offset is formed by an upper bend portion between the upper blade portion and the upper handle portion, the upper bend portion disposed at an upper blade angle relative to the upper blade portion and an upper handle angle relative to the upper handle portion; and
the lower offset is formed by a lower bend portion between the lower blade portion and the lower handle portion, the lower bend portion disposed at a lower blade angle relative to the lower blade portion and a lower handle angle relative to the lower handle portion.

3. The scissors tool of claim 2, wherein a first height of the upper offset and a second height of the lower offset are optimized for one or more of a user's physiology and a use application.

4. The scissors tool of claim 2, wherein:
the upper and the lower cutting members are formed via a three-dimensional printing process; and
the upper blade angle, the upper handle angle, the lower blade angle, and the lower handle are customized for a physiology of a user.

5. The scissors tool of claim 2, wherein:
the upper offset is adjustable through an upper adjustment mechanism associated with one or more of the upper blade angle and the upper handle angle; and
the lower offset is adjustable through a lower adjustment mechanism associated with one or more of the lower blade angle and the lower handle angle.

6. The scissors tool of claim 5, wherein the upper and the lower adjustment mechanisms each comprise a portion of shape-memory material, the portion of the shape-memory material configured to deform plastically through an application of at least one of heat, electrical current, and force.

7. The scissors tool of claim 5, wherein the upper and the lower adjustment mechanisms each comprise one of a selectively locking hinge, a linear ratchet-and-pawl mechanism, and a rotary ratchet-and-pawl mechanism.

8. The scissors tool of claim 1, wherein:
the upper digit-receiving eyelet and the lower digit-receiving eyelet are centered about a vertical plane that is perpendicular to the horizontal cutting plane;
when in the closed position, the upper digit-receiving eyelet and the lower digit-receiving eyelet are spaced apart by an eyelet distance of 0.25 inch to 0.75 inch in the closed position;
the upper digit-receiving eyelet is disposed at an upper eyelet angle relative to the vertical plane; and
the lower digit-receiving eyelet is disposed at a lower eyelet angle relative to the vertical plane.

9. The scissors tool of claim 8, wherein the upper eyelet angle and the lower eyelet angle are optimized for one or more of a user's physiology and a use application.

10. The scissors tool of claim 9, wherein the upper eyelet angle and the lower eyelet angle are adjustable through an eyelet adjustment mechanism associated with each of the upper eyelet and the lower eyelet.

11. The scissors tool of claim 10, wherein the eyelet adjustment mechanism comprises a portion of shape-memory material, the portion of the shape-memory material configured to deform plastically through an application of at least one of heat, electrical current, and force.

12. The scissors tool of claim 10, wherein the eyelet adjustment mechanism comprises one of a selectively locking hinge, a linear ratchet-and-pawl mechanism, and a rotary ratchet-and-pawl mechanism.

13.

14. Precision scissors for performing cutting operations, comprising:
an upper cutting member pivotally coupled with a lower cutting member, the upper cutting member extending proximally to distally from an upper digit-receiving eyelet to an upper blade portion, the lower cutting member extending proximally to distally from a lower digit-receiving eyelet to a lower blade portion, wherein:
the upper and the lower blade portions meet at a horizontal cutting plane;
the upper digit-receiving eyelet and the lower digit-receiving eyelet are positioned above the horizontal cutting plane at respective upper and lower vertical offsets from the horizontal cutting plane; and
the upper and the lower vertical offsets are sized to accommodate a physiology of a user to achieve an ergonomic alignment during use.

15. The precision scissors of claim 14, wherein:
the upper and the lower digit-receiving eyelets are disposed on either side of a vertical plane that is perpendicular to the horizontal cutting plane;
the upper digit-receiving eyelet is disposed at an upper eyelet angle relative to the vertical plane; and
the lower digit-receiving eyelet is disposed at a lower eyelet angle relative to the vertical plane.

16. The precision scissors of claim 15, wherein:
an upper handle portion terminates proximally in the upper digit-receiving eyelet and a lower handle portion terminates proximally in the lower digit-receiving eyelet;
an upper bend portion is disposed between the upper handle portion and the upper blade portion, the upper bend portion disposed at an upper blade angle relative to the upper blade portion and an upper handle angle relative to the upper handle portion;
a lower bend portion is disposed between the lower handle portion and the lower blade portion, the lower bend portion disposed at a lower blade angle relative to the lower blade portion and a lower handle angle relative to the lower handle portion; and
one or more of the upper eyelet angle, the lower eyelet angle, the upper blade angle, the upper handle angle, the lower blade angle, and the lower handle angle are manually adjustable.

17. The precision scissors of claim 14, wherein:
the upper digit-receiving eyelet comprises an upper aperture and the lower digit-receiving eyelet comprises a lower aperture; and
the precision scissors further comprises a number of fit shims, each including:
an outer diameter configured for insertion into at least one of the upper and the lower apertures, wherein the outer diameter is identical across the number of the fit shims; and
an inner diameter configured to receive a user's digit, wherein the inner diameter varies across the number of the fit shims to accommodate different sizes of the user's digit.

18. A precision cutting system, comprising:
a scissors tool extending proximally to distally from a handle portion to a blade portion, the blade portion defining a horizontal cutting plane, the handle portion comprising two digit-receiving eyelets disposed at a vertical offset from the horizontal cutting plane; and
a fit kit comprising a number of interchangeable fit shims for customizing the digit-receiving eyelets, each of the fit shims forming a ring having an identical outer diameter and a varying inner diameter, the identical outer diameter configured for insertion into an aperture of at least one of the digit-receiving eyelets, the varying inner diameter configured to receive the user's digit and approximating a diameter of the user's digit.

19. The precision cutting system of claim 18, wherein the vertical offset of the digit-receiving eyelets is manually adjustable.

20. The precision cutting system of claim 18, wherein the vertical offset between the horizontal cutting plane and the digit-receiving eyelets is sized to accommodate one of a physiology of a user to achieve an ergonomic grip and a use application.
